(19) United States
(12) Patent Application Publication
(10) Pub. No.: US 2008/0145166 A1
(43) Pub. Date: Jun. 19, 2008

(54) MECHANICAL ENGRAVER FOR ENGRAVING

(75) Inventors: CHIH-PEN LIN, Shindian (TW); HUNG-CHANG LEE, Shindian (TW); YU-CHUAN CHEN, Shenzhen (CN); CHUANG LIU, Shenzhen (CN); DA-TAO HUI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/736,530

(22) Filed: Apr. 17, 2007

(30) Foreign Application Priority Data
Dec. 15, 2006 (CN) 200610157534.0

(51) Int. Cl. B23C 5/00

(52) U.S. Cl. 409/229

(57) ABSTRACT

A mechanical engraver (10) includes a rotating plate (11), a first cutting tool (12), and a second cutting tool (13). The rotating plate has a rotating axis. The first cutting tool is mounted on the rotating plate and includes a first knifepoint (1221). The second cutting tool is mounted on the rotating plate and includes a second knifepoint (1321). A distance between the first knifepoint and the rotating axis is longer than a distance between the second knifepoint and the rotating axis. A distance between the first knifepoint and a bottom of the rotating plate is shorter than a distance between the second knifepoint and the bottom of the rotating plate. The first cutting tool includes a straight first cutting edge (1222). The second cutting tool includes a second cutting edge (1322) and a third cutting edge (1323), forming, at the second knifepoint, a cutting angle β less than 180°.

### BACKGROUND OF THE INVENTION

1. Field of the Invention

The present invention relates to a mechanical engraver, and, particularly, to a mechanical engraver used to engrave marks and designs on workpieces.

2. Description of Related Art

Nowadays, portable electronic devices, such as mobile phones, laptops, or personal digital assistants (PDAs), are widely used. These portable electronic devices often require some inscriptions, such as the name of the manufacturer, the model number, date made, and/or trademark symbols, formed on their housings. These inscriptions can be engraved on the portable electronic devices, by means, e.g., of a laser or a mechanical engraver. Mechanical engravers are used more than laser because mechanical engravers tend to be cheaper to purchase, maintain, and operate.

In a typical mechanical engraver, a cutting tool is used to engrave the inscriptions on the housings of portable electronic devices. However, if the housing of a portable electronic device is made of metal or decorated by metal, there is usually a layer of oxide formed on a surface of the housing. The oxide requires to be cut through first before any precise engraving can be achieved. Thus, the cutting tool is firstly used to cut off the oxide and secondly used to engrave marks and designs. Thus, the engraving procedure is complex, time consuming, and costly.

Therefore, a new mechanical engraver is desired in order to overcome the above-described shortcomings.

### SUMMARY OF THE INVENTION

In a preferred embodiment thereof, a mechanical engraver includes a rotating plate, a first cutting tool, and a second cutting tool. The rotating plate has a rotating axis. The first cutting tool is installed on the rotating plate and includes a first knifepoint. The second cutting tool is installed on the rotating plate and including a second knifepoint. A distance between the first knifepoint and the rotating axis is longer than a distance between the second knifepoint and the rotating axis. A distance between the first knifepoint and a bottom of the rotating plate is shorter than a distance between the second knifepoint and the bottom of the rotating plate.

Other advantages and novel features will become more apparent from the following detailed description when taken in conjunction with the accompanying drawings.

### BRIEF DESCRIPTION OF THE DRAWINGS

Many aspects of the present mechanical engraver can be better understood with reference to the following drawings. The components in the various drawings are not necessarily drawn to scale, the emphasis instead being placed upon clearly illustrating the principles of the present mechanical engraver. Moreover, in the drawings, like reference numerals designate corresponding parts throughout the diagrams.

FIG. 1 is an assembled view of a mechanical engraver in accordance with a preferred embodiment;

FIG. 2 is an exploded view of the mechanical engraver shown in FIG. 1;

FIG. 3 is a schematic view of a first cutting tool of the mechanical engraver shown in FIG. 1;

FIG. 4 is a schematic view of a second cutting tool of the mechanical engraver shown in FIG. 1; and

FIG. 5 is a schematic view of the mechanical engraver, shown in FIG. 1, being used to engrave a surface of a workpiece.

### DETAILED DESCRIPTION OF THE INVENTION

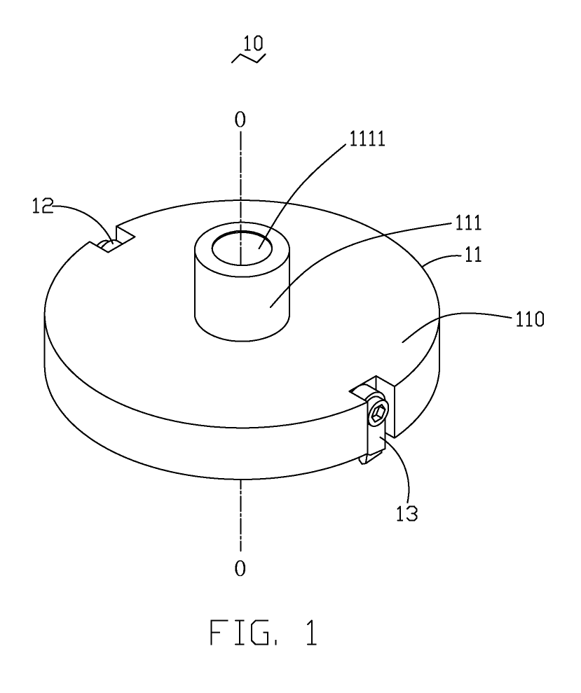

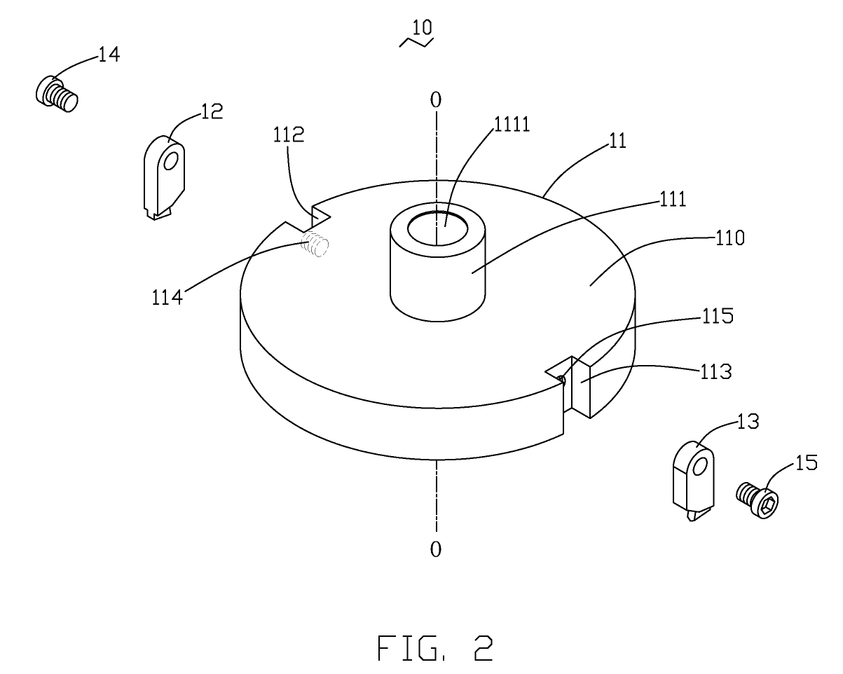

Referring now to the drawings in detail, FIG. 1 and FIG. 2 show a mechanical engraver/graver 10, in accordance with a preferred embodiment. The mechanical engraver 10 includes a rotating plate 11, a first cutting tool 12, a second cutting tool 13, a first holding member 14, and a second holding member 15.

The rotating plate 11 includes a main body 110 and a barrel 111. The main body 110 is approximately a circular plate. The barrel 111 is formed on a central portion of the main body 10 and is integrated with the main body 110. A connecting hole 1111 is defined in a central portion of the barrel 111, and the connecting hole 1111, the main body 110, and the barrel 111 share an axis O-O. A first receiving groove 112 and a second receiving groove 113 are defined in a peripheral portion of the main body 110, and the first receiving groove 112 and the second receiving groove 113 are located symmetrically at two sides (i.e., diametrically) of the axis O-O. A first screw hole 114 is defined in a portion corresponding to the first receiving groove 112 of the main body 110, and a second screw hole 115 is defined in a portion corresponding to the second receiving groove 113 of the main body 110. The first holding member 14 is a bolt corresponding to the first screw hole 114. The second holding member 15 is a bolt corresponding to the second screw hole 115.

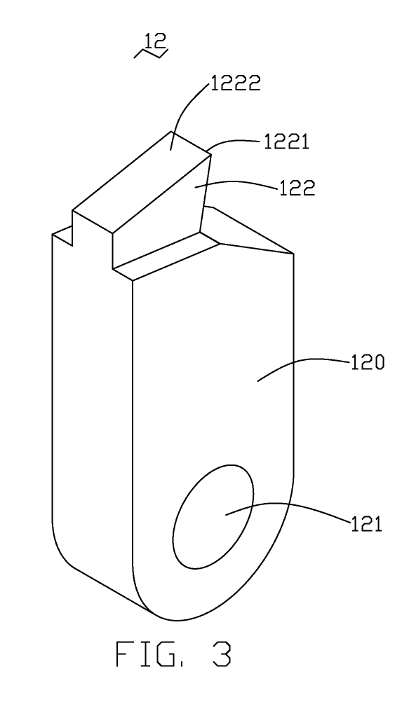

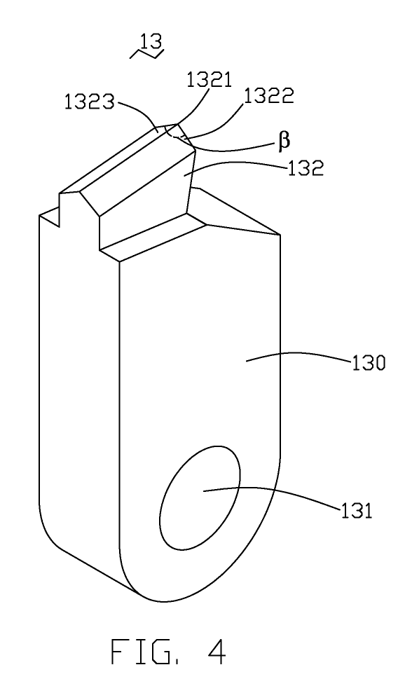

Referring to FIG. 3 and FIG. 4, the first cutting tool 12 includes a first handle (i.e., mounting portion) 120 and a first cutting portion 122. A first holding hole 121 is defined in a central portion of a bottom of the first handle 120. The first cutting portion 122 is advantageously made of diamond or, potentially, another high-hardness material (e.g., cubic boron nitride (CBN) or alumina). The first cutting portion 122 is wedge-shaped and is installed (e.g., adhered or soldered, the solder being a glass or an alloy) on or is integrally formed with a central portion of a top of the first handle 120 (i.e., effectively directly extending from such a top central portion). The first cutting portion 122 includes a first knifepoint 1221 and a first cutting edge 1222. The first knifepoint 1221 (i.e., blade edge) is formed on an end (i.e., at a distal edge) of the first cutting portion 122 (i.e., specifically at the end thereof furthest from the first holding hole 121). The first cutting edge 1222 is straight yet acutely angled relative to the remainder of the first cutting tool 12, contributing to a sharp blade edge at the first knifepoint 1221. As such, the first knifepoint 1221 is configured and, thereby, used to scrape off oxide formed on workpieces.

The second cutting tool 13 includes a second handle (i.e., mounting portion) 130 and a second cutting portion 132. A second holding hole 131 is defined in a central portion of a bottom of the second handle 130. The second cutting portion 132 is also usefully made of diamond or, potentially, another high-hardness material (e.g., cubic boron nitride (CBN) or alumina) and is installed on or integrally formed with a central portion of a top of the second handle 130, in a similar manner as the first cutting tool 12. The second cutting portion 132 includes a second knifepoint 1321, a second cutting edge 1322, and a third cutting edge 1323. The second knifepoint 1321 (i.e., blade edge) is formed on a distal end of the second cutting portion 132, at the linear intersection of the second cutting edge 1322 and the third cutting edge 1323. The second cutting edge 1322 and the third cutting edge 1323 forms, advantageously, a cutting angle β of about 130-150 degrees and, most appropriately, 140 degrees. Because the linear intersection of the second cutting edge 1322 and the third cutting edge 1323 where the second knifepoint 1321 is formed extends farther than another linear intersection of the second cutting edge 1322 and the third cutting edge 1323, the second knifepoint 1321 is formed to be a top end of a triangular pyramid to engrave marks and designs on workpieces.

In assembly, the first cutting tool 12 is installed in the first receiving groove 112 of the rotating plate 11. The first holding member 14 runs/extends through the first holding hole 121 of the first cutting tool 12, and the first holding member 14 is then inserted into and screwed in the first screw hole 114 of the rotating plate 11. In this way the first cutting tool 12 is secured in the first receiving groove 112. The second cutting tool 13 is installed in the second receiving groove 113 of the rotating plate 11. The second holding member 15 runs/extends through the second holding hole 131 of the second cutting tool 13, and the second holding member 15 is then inserted into and screwed in the second screw hole 115 of the rotating plate 11. In this way the second cutting tool 13 is secured in the second receiving groove 113.

A motor (not shown) is connected to the barrel 111 of the rotating plate 11, via the connecting hole 1111, thus configuring the barrel 111 and the rotating plate 11 for rotation by the motor, and the rotating plate 11 can be moved along the axis O-O by the motor. A distance between the first knifepoint 1221 of the first cutting tool 12 and the axis O-O is longer than a distance between the second knifepoint 1321 of the second cutting tool 13 and the axis O-O to permit the first cutting tool 12 the opportunity to remove an oxide layer before the underlying metal is engraved via the second cutting tool 13. A distance between the first knifepoint 1221 of the first cutting tool 12 and a bottom of the rotating plate 11 is shorter than a distance between the second knifepoint 1321 of the second cutting tool 13 and the bottom of the rotating plate 11. This distance differential to the bottom of the rotating plate 11 is advantageously chosen in manner based on a typical oxide layer thickness. By being based on a typical oxide layer thickness, the outermost first cutting tool 12 is usefully sized to scrape off the oxide but not necessarily into metal of the work surface 21.

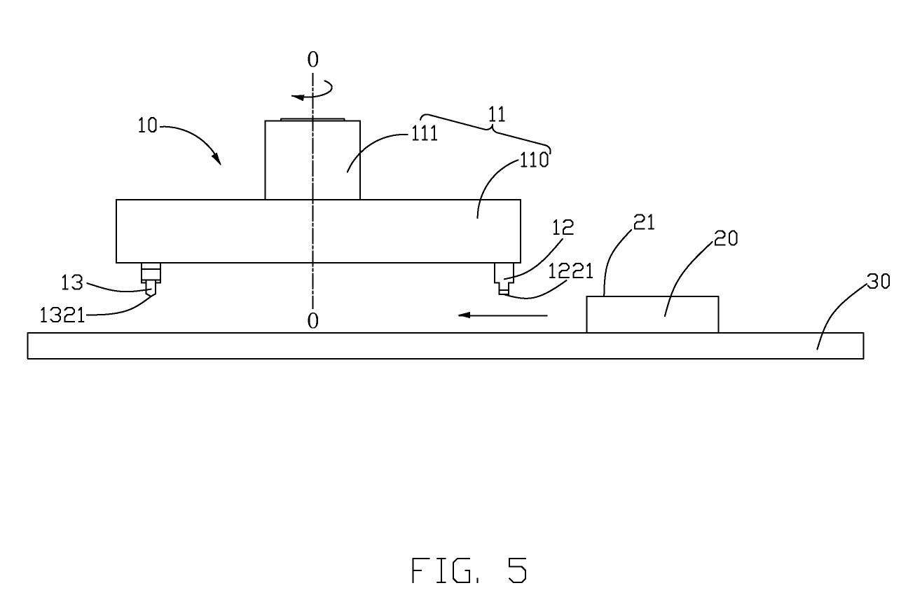

Referring to FIG. 5, in use, the mechanical engraver 10 cooperates with a worktable 30 to engrave a workpiece 20. The workpiece 20 includes a work surface 21 that is to be engraved. The workpiece 20 is placed on the worktable 30 and can move to any position (e.g., x, y; theta angle) on the worktable 30. The work surface 21 is faced towards the mechanical engraver 10. The motor connected with the barrel 111 of the rotating plate 110 is turned on and the rotating plate 11 is rotated around the axis O-O, and the first cutting tool 12 and the second cutting tool 13 are also driven to rotate around the axis O-O. The motor also moves the rotating plate along the axis O-O for scraping off an oxide formed on the work surface 21 of the workpiece 20 in a proper thickness. Because a distance between the first knifepoint 1221 of the first cutting tool 12 and the axis O-O is longer than a distance between the second knifepoint 1321 of the second cutting tool 13 and the axis O-O, the first knifepoint 1221 rotates relative to a peripheral portion of the rotating plate 11, and the second knifepoint 1321 rotates relative an inner portion (i.e., inward of the peripheral portion) of the rotating plate 11.

The workpiece 20 is moved relative to the rotating plate 11 of the mechanical engraver 10. Because the first knifepoint 1221 rotates in a peripheral portion of the rotating plate 11, the work surface 21 is firstly engraved by the first knifepoint 1221. As such, the oxide layer formed on the machining surface 1221 is scraped off by the first knifepoint 1221 while the workpiece 20 moved. After the oxide layer is cut off, the workpiece 20 is moved towards a center of the rotating plate 11, and, thus, the work surface 21 is engraved by the second knifepoint 1321 rotating in a further inward portion of the rotating plate 11.

On the work surface 21, the engraving path formed on the workpiece 20 is engraved along a direction that is a combination of the movement of the workpiece 20 and the rotation of the rotating plate 11. Therefore, the engraving path can be adjusted by means of adjusting velocity vectors of the movement of the workpiece 20 and the rotation of the rotating plate 11 momentarily. For example, if a straight line is required to be engraved on the work surface 21, the moving velocity vector of the workpiece 20 is momentarily adjusted for the combination of the moving velocity vector of the workpiece 20 and all rotating velocity vectors (i.e., an instantaneous velocity vector along a tangent at each point of the edge of the rotating plate 11) is always along a same direction, in this way, the engraving path engraved along the combination of the moving velocity vector of the workpiece 20 and all rotating velocity vectors is formed to be a straight line. If a curve is required to be engraved, the moving velocity vector of the workpiece 20 is momentarily adjusted for the combination of the moving velocity vector of the workpiece 20 and all rotating velocity vectors is always along predetermined directions. In this way, marks and designs can be engraved on the work surface 21.

Understandably, the first cutting tool 12 and the second cutting tool 13 can be installed on (i.e., attached to) the rotating plate 11 in other ways such as welding, in addition to or in lieu of bolting thereto. The cutting angle β can be changed to be other angles that are smaller than 180 degrees to engrave workpieces formed of different materials and/or having different shapes. Additionally, the second cutting portion 132 of the second cutting tool 13 can be in other shapes, such as conical or pyramid with more sides, to form the second knifepoint 1321.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A mechanical engraver, comprising:
a rotating plate having a rotating axis;
a first cutting tool mounted on the rotating plate, the first cutting tool including a first knifepoint; and
a second cutting tool installed on the rotating plate, the second cutting tool including a second knifepoint;
wherein a distance between the first knifepoint and the rotating axis is longer than a distance between the second knifepoint and the rotating axis; and a distance between the first knifepoint and a bottom of the rotating plate is shorter than a distance between the second knifepoint and the bottom of the rotating plate.

2. The mechanical engraver as claimed in claim 1, wherein the rotating plate includes a main body, the main body is approximately a circular plate and defines a first receiving groove and a second receiving groove therein, the first cutting tool is mounted in the first receiving groove, and the second cutting tool is mounted in the second receiving groove.

3. The mechanical engraver as claimed in claim 2, wherein the rotating plate includes a barrel, the barrel is formed on a central portion of the main body, and a connecting hole is defined in a central portion of the barrel.

4. The mechanical engraver as claimed in claim 1, wherein the first cutting tool includes a first handle and a first cutting portion, the first cutting portion extends from a central portion of a top of the first handle, and the first knifepoint is formed on an end of the first cutting portion.

5. The mechanical engraver as claimed in claim 4, wherein the first cutting portion includes a first cutting edge, and the first cutting edge is straight.

6. The mechanical engraver as claimed in claim 1, wherein the second cutting tool includes a second handle and a second cutting portion, the second cutting portion extends from a central portion of a top of the second handle, and the second knifepoint is formed on an end of the second cutting portion.

7. The mechanical engraver as claimed in claim 6, wherein the second cutting portion includes a second cutting edge and a third cutting edge, the second cutting edge and the third cutting edge intersecting at the second knifepoint to form a cutting angle β of about 130-150 degrees.

8. A mechanical engraver, comprising;
a rotating plate;
a first cutting tool mounted on the rotating plate, the first cutting tool including a first cutting edge, the first cutting edge being straight; and
a second cutting tool mounted on the rotating plate, the second cutting tool including a second cutting edge and a third cutting edge, the second cutting edge and the third cutting edge intersecting to form a cutting angle β that is smaller than 180 degrees.

9. The mechanical engraver as claimed in claim 8, wherein the rotating plate includes a main body, the main body is approximately a circular plate and defines a first receiving groove and a second receiving groove therein, the first cutting tool is mounted in the first receiving groove, and the second cutting tool is mounted in the second receiving groove.

10. The mechanical engraver as claimed in claim 9, wherein the rotating plate includes a barrel, the barrel is formed on a central portion of the main body, and a connecting hole is defined in a central portion of the barrel.

11. The mechanical engraver as claimed in claim 8, wherein the rotating plate has an axis, the first cutting tool includes a first knifepoint and the second cutting tool includes a second knifepoint; a distance between the first knifepoint and the rotating axis is longer than a distance between the second knifepoint and the rotating axis, and a distance between the first knifepoint and a bottom of the rotating plate is shorter than a distance between the second knifepoint and the bottom of the rotating plate.

12. The mechanical engraver as claimed in claim 8, wherein the first cutting tool includes a first handle and a first cutting portion, the first cutting portion extends from a central portion of a top of the first handle, and the first knifepoint is formed on an end of the first cutting portion.

13. The mechanical engraver as claimed in claim 12, wherein the second cutting tool includes a second handle and a second cutting portion, the second cutting portion extends from a central portion of a top of the second handle, and the second knifepoint is formed on an end of the second cutting portion.
